(19) United States
(12) Patent Application Publication
(10) Pub. No.: US 2021/0352730 A1
(43) Pub. Date: Nov. 11, 2021

(54) METHOD AND APPARATUS FOR TRANSMITTING AND RECEIVING WIRELESS SIGNAL IN WIRELESS COMMUNICATION SYSTEM

(71) Applicant: LG ELECTRONICS INC., Seoul (KR)

(72) Inventors: Suckchel YANG, Seoul (KR); Seonwook KIM, Seoul (KR); Changhwan PARK, Seoul (KR); Joonkui AHN, Seoul (KR); Sukhyon YOON, Seoul (KR)

(73) Assignee: LG ELECTRONICS INC., Seoul (KR)

(21) Appl. No.: 17/278,009

(22) PCT Filed: Sep. 23, 2019
(86) PCT No.: PCT/KR2019/012336

§ 371 Date: Mar. 19, 2021

Related U.S. Application Data
(60) Provisional application No. 62/734,405, filed on Sep. 21, 2018.
(60) Provisional application No. 62/808,881, filed on Feb. 22, 2019.

(30) Foreign Application Priority Data
Sep. 27, 2018 (KR) 10-2018-0115385

(51) Int. Cl. H04W 74/08; H04W 72/12

(52) U.S. Cl. CPC H04W 74/0833; H04W 16/14; H04W 72/1268

(57) ABSTRACT

The present invention relates to a wireless communication system and, more specifically, to a method comprising the steps of: receiving information on a PRACH resource; and transmitting, on the basis of the information, a PRACH in any one of a plurality of ROs in a PRACH slot of a cell, wherein, on the basis of the cell operating in a U-band, the plurality of ROs is configured to be discontinuous in a time domain, and to an apparatus for the method.

### TECHNICAL FIELD

The present disclosure relates to a wireless communication system, and more particularly, to a method and apparatus for transmitting/receiving a wireless signal.

### BACKGROUND ART

Generally, a wireless communication system is developing to diversely cover a wide range to provide such a communication service as an audio communication service, a data communication service and the like. The wireless communication is a sort of a multiple access system capable of supporting communications with multiple users by sharing available system resources (e.g., bandwidth, transmit power, etc.). For example, the multiple access system may include one of CDMA (code division multiple access) system, FDMA (frequency division multiple access) system, TDMA (time division multiple access) system, OFDMA (orthogonal frequency division multiple access) system, SC-FDMA (single carrier frequency division multiple access) system and the like.

### DISCLOSURE

### Technical Problem

An object of the present disclosure is to provide a method of efficiently performing wireless signal transmission/reception procedures and an apparatus therefor.

Technical tasks obtainable from the present disclosure are non-limited the above-mentioned technical task. And, other unmentioned technical tasks can be clearly understood from the following description by those having ordinary skill in the technical field to which the present disclosure pertains.

### Technical Solution

In one aspect of the present disclosure, a method of performing a random access channel (RACH) by a communication device in a wireless communication system is provided. The method may include: receiving information about a physical random access channel (PRACH) resource; and transmitting a PRACH on any one RACH occasion (RO) among a plurality of ROs within a PRACH slot of a cell based on the information. Based on that the cell operates in an unlicensed band (U-band), the plurality of ROs may be configured to be non-contiguous in a time domain.

In another aspect of the present disclosure, a communication device for use in a wireless communication system is provided. The communication device may include a memory and a processor. The processor may be configured to: receive information about a PRACH resource; and transmit a PRACH on any one RO among a plurality of ROs within a PRACH slot of a cell based on the information. Based on that the cell operates in a U-band, the plurality of ROs may be configured to be non-contiguous in a time domain.

Preferably, based on that the cell operates in a licensed band (L-band), the plurality of ROs may be configured to be contiguous in the time domain.

Preferably, a starting time of the PRACH transmission may be aligned with respect to a starting time of an orthogonal frequency division multiplexing (OFDM) symbol for data within the slot, and a cyclic prefix (CP), a preamble part, and a guard period may be configured depending on formats in the following table.

| Format | TCP | TSEQ | TGP |
|---|---|---|---|
| A1 | 288*k*2^{-u} | 2*2048*k*2^{-u} | 0*k*2^{-u} |
| A2 | 576*k*2^{-u} | 4*2048*k*2^{-u} | 0*k*2^{-u} |
| A3 | 864*k*2^{-u} | 6*2048*k*2^{-u} | 0*k*2^{-u} |
| B1 | 216*k*2^{-u} | 2*2048*k*2^{-u} | 72*k*2^{-u} |
| B2 | 360*k*2^{-u} | 4*2048*k*2^{-u} | 216*k*2^{-u} |
| B3 | 504*k*2^{-u} | 6*2048*k*2^{-u} | 360*k*2^{-u} |
| C0 | 1240*k*2^{-u} | 2048*k*2^{-u} | 1096*k*2^{-u} |
| C2 | 2048*k*2^{-u} | 4*2048*k*2^{-u} | 2912*k*2^{-u} |

In the above table, u is an integer greater than or equal to 0 and related to a subcarrier spacing (SCS), k is a sampling time when u=0, TCP denotes a time duration of the CP, TSEQ denotes a time duration of the preamble part, and TGP denotes a time duration of the GP.

Preferably, the information may include information about an RO starting time and an RO interval, and based on that the cell operates in the U-band, the plurality of ROs may be configured to be non-contiguous in the time domain based on the RO starting time and the RO interval.

Preferably, two adjacent ROs may be configured to be apart from each other by at least one OFDM symbol within the slot according to the RO interval.

Preferably, the wireless communication system may include a 3rd Generation Partnership Project (3GPP) based wireless communication system.

Preferably, the communication device may include an autonomous driving vehicle configured to communicate at least with a terminal, a network, and another autonomous driving vehicle other than the communication device.

Preferably, the communication device may include a radio frequency (RF) unit.

### Advantageous Effects

According to the present disclosure, wireless signal transmission and reception can be efficiently performed in a wireless communication system.

Effects obtainable from the present disclosure may be non-limited by the above mentioned effect. And, other unmentioned effects can be clearly understood from the following description by those having ordinary skill in the technical field to which the present disclosure pertains.

### DESCRIPTION OF DRAWINGS

The accompanying drawings, which are included to provide a further understanding of the disclosure and are incorporated in and constitute a part of this application, illustrate embodiments of the disclosure and together with the description serve to explain the principle of the disclosure. In the drawings:

FIG. 1 illustrates physical channels used in a 3rd generation partnership project (3GPP) system, which is an example of wireless communication systems, and a general signal transmission method using the same;

FIG. 2 illustrates a radio frame structure;

FIG. 3 illustrates a resource grid of a slot;

FIG. 4 illustrates a wireless communication system supporting an unlicensed band;

FIG. 5 illustrates a method of occupying resources in an unlicensed band;

FIG. 6 illustrates a random access channel (RACH) procedure;

FIGS. 7 to 9 illustrate physical RACH (PRACH) structures and RACH occasions (ROs);

FIG. 10 illustrates listen-before-talk (LBT) blocking resulting from a PRACH;

FIGS. 11 to 14 illustrate PRACH and RACH procedures according to examples of the present disclosure; and

FIGS. 15 to 18 illustrate communication systems and wireless devices applied to the present disclosure.

### BEST MODE

Embodiments of the present disclosure are applicable to a variety of wireless access technologies such as code division multiple access (CDMA), frequency division multiple access (FDMA), time division multiple access (TDMA), orthogonal frequency division multiple access (OFDMA), and single carrier frequency division multiple access (SC-FDMA). CDMA can be implemented as a radio technology such as Universal Terrestrial Radio Access (UTRA) or CDMA2000. TDMA can be implemented as a radio technology such as Global System for Mobile communications (GSM)/General Packet Radio Service (GPRS)/Enhanced Data Rates for GSM Evolution (EDGE). OFDMA can be implemented as a radio technology such as Institute of Electrical and Electronics Engineers (IEEE) 802.11 (Wireless Fidelity (Wi-Fi)), IEEE 802.16 (Worldwide interoperability for Microwave Access (WiMAX)), IEEE 802.20, and Evolved UTRA (E-UTRA). UTRA is a part of Universal Mobile Telecommunications System (UMTS). 3rd Generation Partnership Project (3GPP) Long Term Evolution (LTE) is part of Evolved UMTS (E-UMTS) using E-UTRA, and LTE-Advanced (A) is an evolved version of 3GPP LTE. 3GPP NR (New Radio or New Radio Access Technology) is an evolved version of 3GPP LTE/LTE-A.

As more and more communication devices require a larger communication capacity, there is a need for mobile broadband communication enhanced over conventional radio access technology (RAT). In addition, massive Machine Type Communications (MTC) capable of providing a variety of services anywhere and anytime by connecting multiple devices and objects is another important issue to be considered for next generation communications. Communication system design considering services/UEs sensitive to reliability and latency is also under discussion. As such, introduction of new radio access technology considering enhanced mobile broadband communication (eMBB), massive MTC, and Ultra-Reliable and Low Latency Communication (URLLC) is being discussed. In the present disclosure, for simplicity, this technology will be referred to as NR (New Radio or New RAT).

For the sake of clarity, 3GPP NR is mainly described, but the technical idea of the present disclosure is not limited thereto.

In a wireless communication system, a user equipment (UE) receives information through downlink (DL) from a base station (BS) and transmit information to the BS through uplink (UL). The information transmitted and received by the BS and the UE includes data and various control information and includes various physical channels according to type/usage of the information transmitted and received by the UE and the BS.

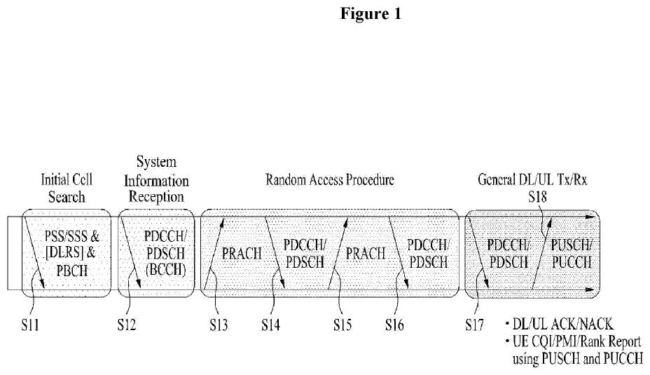

FIG. 1 illustrates physical channels used in a 3GPP NR system and a general signal transmission method using the same.

When a UE is powered on again from a power-off state or enters a new cell, the UE performs an initial cell search procedure, such as establishment of synchronization with a BS, in step S101. To this end, the UE receives a synchronization signal block (SSB) from the BS. The SSB includes a primary synchronization signal (PSS), a secondary synchronization signal (SSS), and a physical broadcast channel (PBCH). The UE establishes synchronization with the BS based on the PSS/SSS and acquires information such as a cell identity (ID). The UE may acquire broadcast information in a cell based on the PBCH. The UE may receive a DL reference signal (RS) in an initial cell search procedure to monitor a DL channel status.

After initial cell search, the UE may acquire more specific system information by receiving a physical downlink control channel (PDCCH) and receiving a physical downlink shared channel (PDSCH) based on information of the PDCCH in step S102.

The UE may perform a random access procedure to access the BS in steps S103 to S106. For random access, the UE may transmit a preamble to the BS on a physical random access channel (PRACH) (S103) and receive a response message for preamble on a PDCCH and a PDSCH corresponding to the PDCCH (S104). In the case of contention-based random access, the UE may perform a contention resolution procedure by further transmitting the PRACH (S105) and receiving a PDCCH and a PDSCH corresponding to the PDCCH (S106).

After the foregoing procedure, the UE may receive a PDCCH/PDSCH (S107) and transmit a physical uplink shared channel (PUSCH)/physical uplink control channel (PUCCH) (S108), as a general downlink/uplink signal transmission procedure. Control information transmitted from the UE to the BS is referred to as uplink control information (UCI). The UCI includes hybrid automatic repeat and request acknowledgement/negative-acknowledgement (HARQ-ACK/NACK), scheduling request (SR), channel state information (CSI), etc. The CSI includes a channel quality indicator (CQI), a precoding matrix indicator (PMI), a rank indicator (RI), etc. While the UCI is transmitted on a PUCCH in general, the UCI may be transmitted on a PUSCH when control information and traffic data need to be simultaneously transmitted. In addition, the UCI may be aperiodically transmitted through a PUSCH according to request/command of a network.

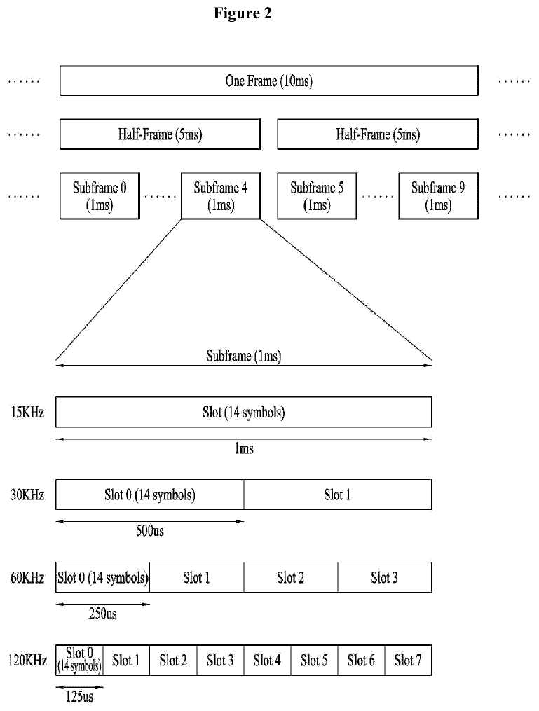

FIG. 2 illustrates a radio frame structure. In NR, uplink and downlink transmissions are configured with frames. Each radio frame has a length of 10 ms and is divided into two 5-ms half-frames (HF). Each half-frame is divided into five 1-ms subframes (SFs). A subframe is divided into one or more slots, and the number of slots in a subframe depends on subcarrier spacing (SCS). Each slot includes 12 or 14 Orthogonal Frequency Division Multiplexing (OFDM) symbols according to a cyclic prefix (CP). When a normal CP is used, each slot includes 14 OFDM symbols. When an extended CP is used, each slot includes 12 OFDM symbols.

Table 1 exemplarily shows that the number of symbols per slot, the number of slots per frame, and the number of slots per subframe vary according to the SCS when the normal CP is used.

TABLE 1

| SCS (15*2\hat{ }u) | N^{slot}_{symb} | ^{Nframe, u}ₛₗₒₜ | N^{subframe, u}ₛₗₒₜ |
|---|---|---|---|
| 15 KHz (u = 0) | 14 | 10 | 1 |
| 30 KHz (u = 1) | 14 | 20 | 2 |
| 60 KHz (u = 2) | 14 | 40 | 4 |
| 120 KHz (u = 3) | 14 | 80 | 8 |
| 240 KHz (u = 4) | 14 | 160 | 16 |

*N^{slot}_{symb}: Number of symbols in a slot
*N^{frame, u}ₛₗₒₜ: Number of slots in a frame
*N^{subframe, u}ₛₗₒₜ: Number of slots in a subframe

Table 2 illustrates that the number of symbols per slot, the number of slots per frame, and the number of slots per subframe vary according to the SCS when the extended CP is used.

TABLE 2

| SCS (15*2\hat{ }u) | N^{slot}_{symb} | N^{frame, u}ₛₗₒₜ | N^{subframe, u}ₛₗₒₜ |
|---|---|---|---|
| 60 KHz (u = 2) | 12 | 40 | 4 |

The structure of the frame is merely an example. The number of subframes, the number of slots, and the number of symbols in a frame may vary.

In the NR system, OFDM numerology (e.g., SCS) may be configured differently for a plurality of cells aggregated for one UE. Accordingly, the (absolute time) duration of a time resource (e.g., an SF, a slot or a TTI) (for simplicity, referred to as a time unit (TU)) consisting of the same number of symbols may be configured differently among the aggregated cells. Here, the symbols may include an OFDM symbol (or a CP-OFDM symbol) and an SC-FDMA symbol (or a discrete Fourier transform-spread-OFDM (DFT-s-OFDM) symbol).

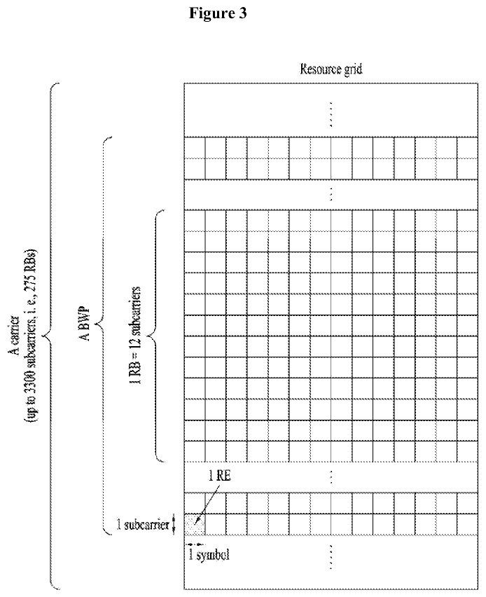

FIG. 3 illustrates a resource grid of a slot. A slot includes a plurality of symbols in the time domain. For example, when the normal CP is used, the slot includes 14 symbols. However, when the extended CP is used, the slot includes 12 symbols. A carrier includes a plurality of subcarriers in the frequency domain. A resource block (RB) is defined as a plurality of consecutive subcarriers (e.g., 12 consecutive subcarriers) in the frequency domain. A bandwidth part (BWP) may be defined to be a plurality of consecutive physical RBs (PRBs) in the frequency domain and correspond to a single numerology (e.g., SCS, CP length, etc.). The carrier may include up to N (e.g., 5) BWPs. Data communication may be performed through an activated BWP, and only one BWP may be activated for one UE. In the resource grid, each element is referred to as a resource element (RE), and one complex symbol may be mapped to each RE.

In recent years, data traffic has significantly increased with the advent of smart devices. Thus, the 3GPP NR system has also considered use of an unlicensed band for cellular communication as in License-Assisted Access (LAA) of the legacy 3GPP LTE system. However, unlike the LAA, a NR cell in the unlicensed-band (NR UCell) aims to support standalone (SA) operation. To this end, PUCCH, PUSCH, and/or PRACH transmission may be supported.

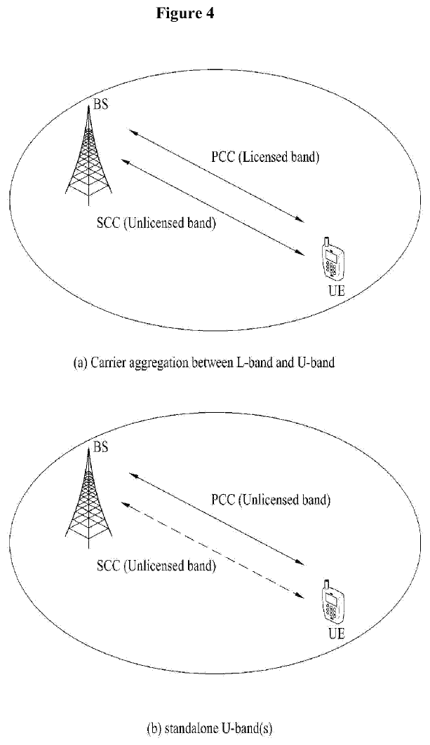

FIG. 4 illustrates a wireless communication system supporting an unlicensed band. For convenience, a cell operating in a licensed band (hereinafter, L-band) is defined as an LCell and a carrier of the LCell is defined as a (DL/UL) LCC. A cell operating in an unlicensed band (hereinafter, U-band) is defined as a UCell and a carrier of the UCell is defined as a (DL/UL) UCC. A carrier of a cell may represent an operating frequency (e.g., a center frequency) of the cell. A cell/carrier (e.g., CC) may generically be referred to as a cell.

When carrier aggregation is supported, one UE may transmit and receive signals to and from a BS in a plurality of aggregated cells/carriers. If a plurality of CCs is configured for one UE, one CC may be configured as a primary CC (PCC) and the other CCs may be configured as secondary CCs (SCCs). Specific control information/channels (e.g., a CSS PDCCH and PUCCH) may be configured to transmit and receive signals only in the PCC. Data may be transmitted and received in the PCC and/or the SCCs. In FIG. 4(a), the UE and the BS transmit and receive signals in the LCC and the UCC (non-standalone (NSA) mode). In this case, the LCC may be configured as the PCC and the UCC may be configured as the SCC. If a plurality of LCCs is configured for the UE, one specific LCC may be configured as the PCC and the other LCCs may be configured as the SCCs. FIG. 4(a) corresponds to LAA of the 3GPP LTE system. FIG. 4(b) illustrates the case in which the UE and the BS transmit and receive signals in one or more UCCs without the LCC (SA mode). In this case, one of the UCCs may be configured as the PCC and the other UCCs may be configured as the SCCs. Both the NSA mode and the SA mode may be supported in an unlicensed band of the 3GPP NR system.

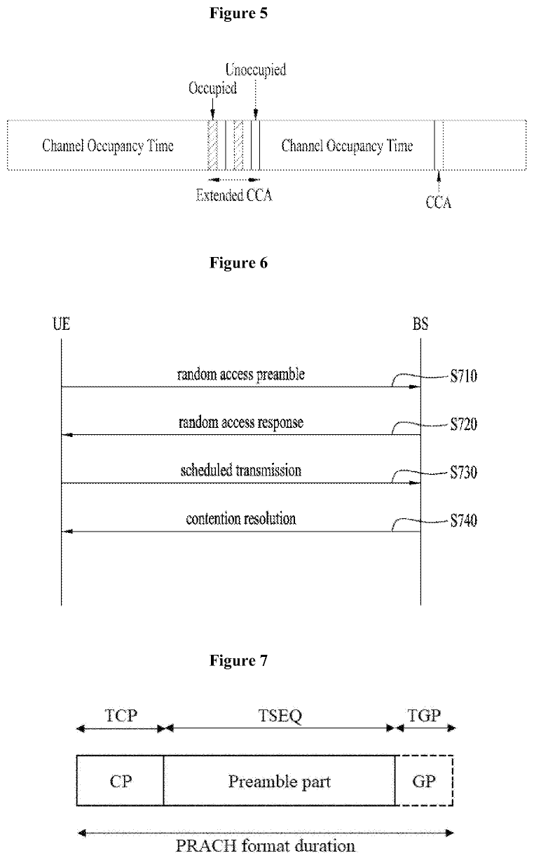

FIG. 5 illustrates a method of occupying resources in an unlicensed band. According to regional regulations concerning the unlicensed band, a communication node in the unlicensed band needs to determine, before signal transmission, whether other communication nodes use a channel. Specifically, the communication node may first perform carrier sensing (CS) before signal transmission to check whether other communication nodes transmit signals. If it is determined that other communication nodes do not transmit signals, this means that clear channel assessment (CCA) is confirmed. When there is a predefined CCA threshold or a CCA threshold configured by higher layer (e.g., RRC) signaling, if energy higher than the CCA threshold is detected in a channel, the communication node may determine that the channel is in a busy state and, otherwise, the communication node may determine that the channel is in an idle state. For reference, in Wi-Fi standard (802.11ac), the CCA threshold is set to −62 dBm for a non-Wi-Fi signal and to −82 dBm for a Wi-Fi signal. Upon determining that the channel is in an idle state, the communication node may start to transmit signals in the UCell. The above processes may be referred to as listen-before-talk (LBT) or a channel access procedure (CAP). LBT and CAP may be used interchangeably.

### Embodiment: RACH

To support (initial) random access of the UE, a 4-step random access channel (RACH) procedure has been defined in NR (as well as LTE). The 4-step RACH procedure includes: 1) PRACH preamble (Msg1) transmission from the UE to the BS; 2) random access response (RAR) (Msg2) transmission from the BS to the UE; 3) Msg3 transmission from the UE to the BS; and 4) Msg4 transmission from the BS to the UE (for contention resolution.

FIG. 6 illustrates a conventional 4-step RACH procedure. Hereinafter, information/signals transmitted in each step and operations performed in each step will be described with reference to FIG. 6.

1) Msg1 (PRACH): The UE transmits Msg1 to the BS (S710). Each Msg1 may be identified by a time/frequency resource (RACH occasion (RO)) for transmission of a random access (RA) preamble and a preamble index (RA preamble index (RAPID)).

2) Msg2 (RAR PDSCH): Msg2 is a message in response to Msg1. The BS transmits Msg2 to the UE (S720). To receive Msg2, the UE may perform PDCCH monitoring to check whether there is a RA-RNTI based PDCCH (for example, a PDCCH of which the CRC is masked with the RA-RNTI) within a time window associated with Msg1 (RAR window). Upon receiving the PDCCH masked with the RA-RNTI, the UE may receive a RAR on a PDSCH indicated by the RA-RNTI PDCCH.

3) Msg3 (PUSCH): The UE transmits Msg3 to the BS (S730). Msg3 transmission is performed based on a UL grant in the RAR. Msg3 may include a contention resolution identity (ID) (and/or buffer status report (BSR) information, an RRC connection request, etc.) Msg3 (PUSCH) may be retransmitted based on a HARQ process.

4) Msg4 (PDSCH): The BS transmits Msg4 to the UE (S740). Msg4 may include a UE (global) ID for contention resolution (and/or RRC connection related information). The success or failure of the contention resolution may be determined by Msg4.

When the UE does not successfully receive Msg2/Msg4, the UE retransmits Msg1. In this case, the UE increases the transmit power of Msg1 (power ramping) and increases a RACH retransmission counter value. If the RACH retransmission counter value reaches to a maximum value, the UE determines the failure of the RACH procedure. In this case, the UE performs a random backoff procedure and then initializes RACH-related parameter(s) (e.g., RACH retransmission counter) to resume the RACH procedure.

FIG. 7 illustrates the structure of a PRACH format. Referring to FIG. 7, the PRACH format may include the following elements.
CP (Cyclic Prefix): The CP serves to prevent interference generated from previous/front (OFDM) symbol(s) and group RACH preamble signals received by the BS with various time delays into the same time zone. That is, if the CP is configured to match with the maximum radius of a cell, RACH preambles transmitted by UEs in the cell on the same resource are included in a RACH reception window having a PRACH preamble length configured by the BS for RACH reception. In general, the length of the CP (TCP) is set to be more than or equal to a maximum round trip delay of cell coverage.
Preamble part: A sequence is defined for the BS to perform signal detection. The preamble part may consist of one sequence. Alternatively, short sequence(s) may be repeated to configure the preamble part.
GT (Guard Time): The GT is defined to prevent a PRACH signal received by the BS with a delay after being transmitted at the farthest point from the BS with respect to RACH coverage from causing interference to a signal received after a PRACH symbol duration. The UE transmits no signal in the GT duration. The GT may not be explicitly defined in the PRACH preamble structure. In this case, the GT may be estimated/defined as a part obtained by excluding {CP+preamble part} from the PRACH preamble.

Table 3 shows the structure of a short PRACH format defined for the NR system. The short PRACH format has a short sequence length (e.g., length=139) and is used for small coverage.

TABLE 3

| | L_{RA} | TCP | TSEQ | TGP | Maximum Cell |
|---|---|---|---|---|---|
| Format | (length) | (duration) | (duration) | (duration) | radius (m) |
| A1 | 139 | 288*k*2^{-u} | 2*2048*k*2^{-u} | 0*k*2^{-u} | 938 |
| A2 | 139 | 576*k*2^{-u} | 4*2048*k*2^{-u} | 0*k*2^{-u} | 2109 |
| A3 | 139 | 864*k*2^{-u} | 6*2048*k*2^{-u} | 0*k*2^{-u} | 3516 |
| B1 | 139 | 216*k*2^{-u} | 2*2048*k*2^{-u} | 72*k*2^{-u} | 469 |
| B2 | 139 | 360*k*2^{-u} | 4*2048*k*2^{-u} | 216*k*2^{-u} | 1055 |
| B3 | 139 | 504*k*2^{-u} | 6*2048*k*2^{-u} | 360*k*2^{-u} | 1758 |
| B4 | 139 | 936*k*2^{-u} | 12*2048*k*2^{-u} | 792*k*2^{-u} | 3867 |
| C0 | 139 | 1240*k*2^{-u} | 2048*k*2^{-u} | 1096*k*2^{-u} | 5300 |
| C2 | 139 | 2048*k*2^{-u} | 4*2048*k*2^{-u} | 2912*k*2^{-u} | 9200 |

*u denotes an SCS (u = 0 to 3) (see Table 1).
*The short PRACH format is aligned with a data OFDM symbol within a slot. Accordingly, the start point of the short PRACH format is aligned with that of the OFDM symbol. The total duration of the short PRACH format (including the GP) is defined as a multiple of a data OFDM symbol duration. When IFFT size = 2048, the data OFDM symbol consists of {CP + data part}, where the CP includes 144 samples and the data part includes 2048 samples.
*k denotes a sampling time (Ts) when u = 0. Here, the sampling time refers to a time interval between samples and is defined as 1/(SCS*IFFT size). When IFFT size = 2048, k may be given as 32.5 ns.

A PRACH preamble may be transmitted on an RO within a slot. That is, the RO is a time/frequency resource unit for transmitting the PRACH preamble. Hereinafter, several terms related to RO allocation are defined as follows.

1) Synchronization signal block (SSB): The SSB may be defined as a signal/resource block in which a synchronization and/or PBCH signal is transmitted. A plurality of different SSBs including different sequences/parameters/contents (corresponding to (analog) TX beams of different BSs) may be time division multiplexed (TDMed) and transmitted.

2) SSB-to-RO mapping ratio: The SSB-to-RO mapping ratio may be defined as the number of ROs mapped to a single SSB (within one RACH association cycle). For example, when the SSB-to-RO mapping ratio is set to 1-to-N, N ROs may be mapped to each SSB (within one RACH association cycle).

3) RACH slot: The RACH slot may be defined as a slot in which RO mapping/allocation is allowed (within a single or a plurality of specific radio frames). Depending on configurations, the RO may be mapped to all or some specific symbols (e.g., first or last symbol). Such a configuration may be included in system information.

4) RACH association cycle: The RACH association cycle may be defined as a minimum time period required to map/allocate (N) ROs per SSB to all SSBs once, where the number (N) of ROs for each SSB is given by the SSB-to-RO mapping ratio (e.g., 1-to-N).

5) RACH association (pattern) period: The RACH association period may be defined as a minimum time period including one RACH association cycle and scaled in a unit of 10*2k [ms] (k=0, 1, 2, 3, 4). The RACH association pattern period may be defined as a time period of 160 [ms] including one or multiple RACH association periods.

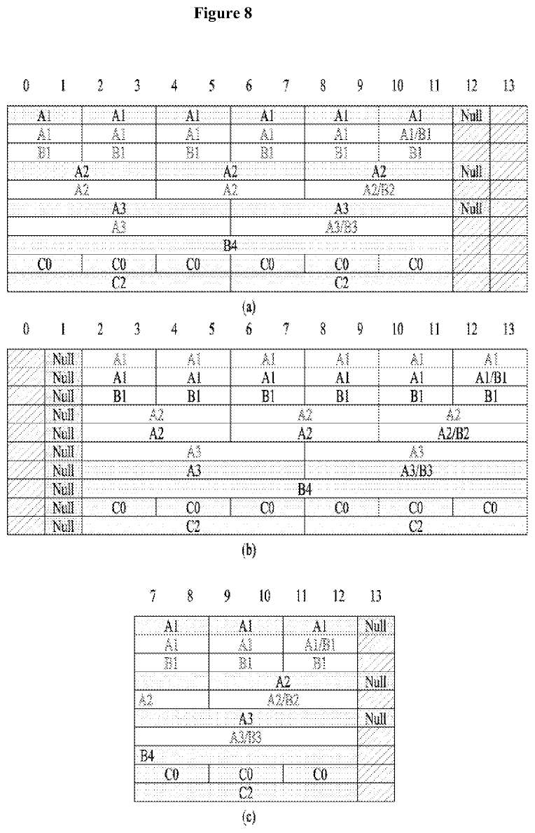

FIG. 8 illustrates an RO in a RACH slot. The starting OFDM symbol of a PRACH format in the RACH slot may vary depending on the UL/DL OFDM symbol configuration of the RACH slot. For example, the starting OFDM symbol may be one of OFDM symbols #0, #2, and #7. Further, the PRACH format may vary depending on the starting OFDM symbol (see Table 3).

Referring to FIG. 8 (a), when the index of the starting OFDM symbol is #0, the index of an OFDM symbol capable of starting PRACH transmission may be given by {0, 2, 4, 8, 10}, {0, 4, 8}, or {0, 6}. One of the last two OFDM symbols in the slot may be used as a guard period (GP) (A1/A2/A3), and the other OFDM symbol may be used to transmit a UL signal such as a PUCCH, an SRS, etc. Referring to FIG. 8 (b), when the starting OFDM symbol index is #2, the index of an OFDM symbol capable of starting PRACH transmission may be given by {2, 4, 8, 10, 12}, {2, 6, 10}, or {2, 8}. Since no guard OFDM symbol is allocated to the end of the PRACH slot, the second last OFDM symbol of the slot is used as the GP. Referring to FIG. 8 (c), when the starting OFDM symbol index is #7, the index of an OFDM symbol capable of starting PRACH transmission may be given by {7, 9, 11}, {7, 9}, {7}, or {9}. The last OFDM symbol of the slot is used as the GP (A1/A2/A3).

In a U-band environment, the UE and BS may need to perform UL LBT and DL LBT, respectively, before MsgX (X=1, 2, 3, or 4) transmission in the 4-step RACH procedure. In particular, to configure/allocate TDMed resources (such that the resources are contiguous in the time domain) i) between a plurality of PRACH preambles or ii) between a PRACH preamble and other UL signals/channels (e.g., PUSCH, PUCCH, etc.), the format of the PRACH preamble may need to be configured so that 1) different UEs do not block their LBT with each other and, at the same time, 2) a CCA gap for performing the LBT is secured before transmission of the PRACH preamble.

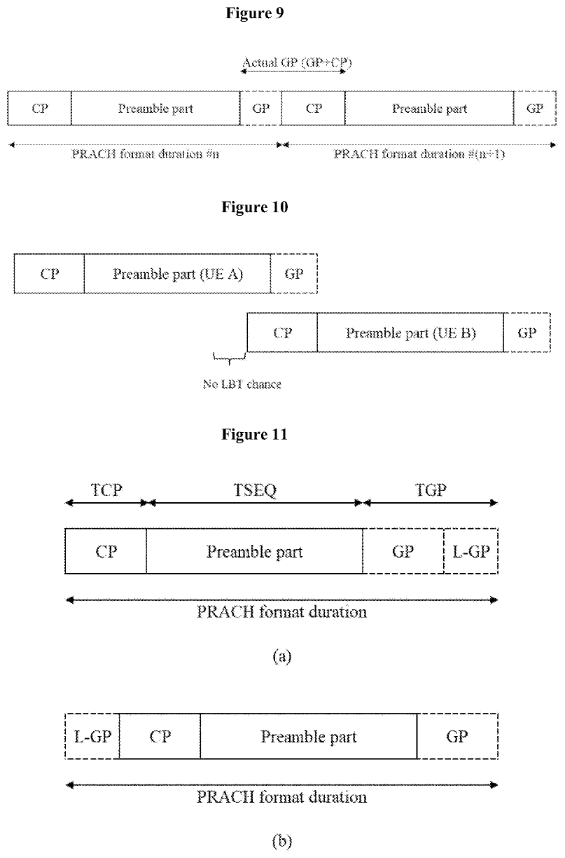

FIG. 9 illustrate a conventional NR PRACH format. The PRACH format shown in Table 3 is designed in consideration of an L-band environment. Referring to FIG. 9, the GP length of the PRACH format is set to be shorter than an actually required length. Considering that the CP is eliminated while the BS processes a received signal, {GP of RACH format+CP of next OFDM symbol} may be used as the GP. Accordingly, TGP of Table 3 is set to be shorter than an actually required length in consideration of the CP length of an OFDM symbol. For example, the GP length is shorter than the CP length for all PRACH formats except PRACH format C2, and TGP is set to 0 for PRACH format A.

FIG. 10 illustrates LBT blocking resulting from a PRACH. It is assumed that under the situation of FIG. 9, UE A intends to transmit its PRACH preamble in PRACH format duration #n and UE B intends to transmit its PRACH preamble in PRACH format duration #(n+1). If UE A is distant from UE B, the PRACH preamble part of UE A may intrude into the CP in PRACH format duration #(n+1) due to propagation delay. In this case, the PRACH preamble of UE A has no effects on the preamble part of UE B, but UE B fails in the LBT at all times because the PRACH preamble signal of UE A is present immediately before PRACH format duration #(n+1). The same problem may occur when the signal of UE B is a PUSCH/PUCCH.

To overcome such a problem, the present disclosure proposes a PRACH format structure suitable for a U-band and a RACH procedure based on the PRACH format structure. The proposed PRACH format structure may be configured in the following order in the time domain: {CP+preamble part+GP}. The length of the GP (or the number of samples for the GP) may be set equal to the length of the CP. To secure a CCA gap for the LBT operation, the PRACH format may be configured by adding a GP (e.g., L-GP) duration with a specific length (or a specific number of samples) to the front or rear part of the PRACH format. FIG. 11 illustrates a PRACH format structure according to an embodiment of the present disclosure. Referring to FIG. 11, the PRACH format may be configured as follows: {L-GP+CP+preamble part+GP} (FIG. 11(b)) or {CP+preamble part+GP+L-GP} (FIG. 11(a)).

Hereinafter, a description will be given of a method of determining the length (or the number of samples) of each component (e.g., CP, GP, L-GP, etc.) included in a PRACH format based on the above structure. The total (time) length of one PRACH format is referred to as a PRACH format duration.

1) Method 1

A. Total PRACH format duration (S; Ns)

i. The total PRACH format duration may be determined as a multiple of an OFDM symbol, for example, S symbols=Ns samples. For example, when one (OFDM) symbol consists of 2192 [=144 (CP)+2048 (data part)] samples, the PRACH format duration may be determined as S symbol(s) (=Ns=2192*S), where S may be an integer greater than or equal to 1.

ii. Alternatively, the total PRACH format duration may be determined as a multiple of a half-symbol, for example, S symbol(s)+0.5 symbol=Ns samples. For example, the PRACH format duration may be determined as (S+0.5) symbols=(Ns=2192*(S+0.5)) samples.

B. Preamble part length (P; Np=TSEQ)

i. The preamble part length may be determined as the number of samples corresponding to the preamble part length, for example, Np samples. Referring to Table 3, the preamble part length may be 139.

ii. For example, the preamble part length may be determined as 2048*k (k=1, 2, . . . )=Np samples. For the preamble part, a short sequence may be repeated in the time domain.

C. L-GP length for CCA gap (T; Nt)

i. The L-GP length may be determined as a predefined/preconfigured specific absolute time, for example, T [usec]=Nt samples.

ii. For example, the L-GP length may be determined as T=25 usec=(Nt=768*2\hat{ }u) samples, where u denotes the SCS of Table 1.

iii. In another example, Nt may be determined as the number of samples corresponding to one symbol (or a multiple thereof) or 0.5 symbols (or a multiple thereof).

D. CP length=GP length (D; Nd=TCP or TGP)

i. After determination of the lengths of the PRACH format duration, preamble part, and L-GP, the CP/GP length may be determined as follows: CP/GP length={Ns−(Np+Nt)}/2.

E. Note 1

i. The value of S for the PRACH format duration may be determined as a minimum integer satisfying {Ns−(Np+Nt+2Nd)>0}.

ii. To transmit a PRACH format including S or (S+0.5) symbols, consecutive ROs may be mapped/allocated within one RACH slot in the time domain.

F. Note 2

i. After determination of the length of each component, the PRACH format may be defined as follows: Opt 1) {L-GP+CP+preamble part+GP} or {CP+preamble part+GP+L-GP}; Opt 2) {CP+preamble part+GP} by excluding the L-GP; Opt 3) {CP+preamble part} by excluding both the L-GP and GP; or Opt 4) {L-GP+CP+preamble part} or {CP+preamble part+L-GP} by excluding the GP.

ii. In Opt 1, the starting time of the L-GP or the ending time of the GP or the starting time of the CP or the ending time of L-GP may be aligned with the boundary of a symbol or half-symbol. In Opt 2, the starting time of the CP or the ending time of the GP may be aligned with the boundary of a symbol or half-symbol. In Opt 3, the starting time of the CP or the ending time of the preamble part may be aligned with the boundary of a symbol or half-symbol. In Opt 4, the starting time of the L-GP or the ending time of the preamble part or the starting time of the CP or the ending time of L-GP may be aligned with the boundary of a symbol or half-symbol. In this case, an interval between the start/ending times of each PRACH format (resource) may be set as a multiple of the PRACH format duration (in each RACH slot or in a RACH slot group including a plurality of consecutive RACH slots).

iii. The starting time of the CP or L-GP or the ending time of the GP, L-GP, or preamble part of the PRACH format may be aligned with respect to the boundary of a DL slot or symbol received by the UE.

2) Method 2

A. Total PRACH format duration (S; Ns)

i. The total PRACH format duration may be determined as a multiple of an OFDM symbol, for example, S symbols=Ns samples. For example, when one (OFDM) symbol consists of 2192 samples, the PRACH format duration may be determined as S symbol(s) (=Ns=2192*S), where S may be an integer greater than or equal to 1.

ii. Alternatively, the total PRACH format duration may be determined as a multiple of a half-symbol, for example, S symbol(s)+0.5 symbol=Ns samples.

B. Preamble part length (P; Np=TSEQ)

i. The preamble part length may be determined as the number of samples corresponding to the preamble part length, for example, Np samples. Referring to Table 3, the preamble part length may be 139.

ii. For example, the preamble part length may be determined as 2048*k (k=1, 2, . . . )=Np samples. For the preamble part, a short sequence may be repeated in the time domain.

C. CP length=GP length (D; Nd)

i. The CP/GP length may be determined as a predefined/preconfigured specific absolute time, for example, D [used]=Nd samples.

ii. For example, the CP/GP length may be determined in consideration of coverage related to propagation delay and channel delay spread.

iii. For example, the CP/GP length may be determined as one of the CP lengths (TCP of Table 3) proposed for PRACH formats A, B, or C in the NR PRACH table (i.e., Table 3).

D. L-GP length for CCA gap (Ncg)

i. After determination of the lengths of the PRACH format duration, preamble part, and CP/GP, the L-GP length may be determined as follows: L-GP length={Ns−(Np+2Nd)}.

E. Note 1

i. The value of S for the PRACH format duration may be determined as a minimum integer satisfying {Ns−(Np+2Nd+Ncg)>0}.

ii. Ncg is a predefined/preconfigured specific absolute time. For example, Ncg may be defined as follows: Ncg=768*2\hat{ }u samples (=25 usec)), where u denotes the SCS of Table 1.

iii. In another example, Ncg may be determined as the number of samples corresponding to one symbol (or a multiple thereof) or 0.5 symbols (or a multiple thereof).

iv. To transmit a PRACH format including S or (S+0.5) symbols, consecutive ROs may be mapped/allocated within one RACH slot in the time domain.

F. Note 2

i. After determination of the length of each component, the PRACH format may be defined as follows: Opt 1) {L-GP+CP+preamble part+GP} or {CP+preamble part+GP+L-GP}; Opt 2) {CP+preamble part+GP} by excluding the L-GP; Opt 3) {CP+preamble part} by excluding both the L-GP and GP; or Opt 4) {L-GP+CP+preamble part} or {CP+preamble part+L-GP} by excluding the GP.

ii. In Opt 1, the starting time of the L-GP or the ending time of the GP or the starting time of the CP or the ending time of L-GP may be aligned with the boundary of a symbol or half-symbol. In Opt 2, the starting time of the CP or the ending time of the GP may be aligned with the boundary of a symbol or half-symbol. In Opt 3, the starting time of the CP or the ending time of the preamble part may be aligned with the boundary of a symbol or half-symbol. In Opt 4, the starting time of the L-GP or the ending time of the preamble part or the starting time of the CP or the ending time of L-GP may be aligned with the boundary of a symbol or half-symbol. In this case, an interval between the start/ending times of each PRACH format (resource) may be set as a multiple of the PRACH format duration (in each RACH slot or in a RACH slot group including a plurality of consecutive RACH slots).

iii. The starting time of the CP or L-GP or the ending time of the GP, L-GP, or preamble part of the PRACH format may be aligned with respect to the boundary of a DL slot or symbol received by the UE.

3) Method 3

A. Total PRACH format duration

i. The total PRACH format duration may be determined as one of the PRACH format durations (TCP+TSEQ+TGP of Table 3) proposed for preamble formats A, B, or C in the NR PRACH table (i.e., Table 3).

B. Preamble part length

i. The preamble part length may be determined as one of the preamble part lengths (TSEQ of Table 3) proposed for preamble formats A, B, or C in the NR PRACH table (i.e., Table 3).

C. CP length=GP length

i. The CP/GP length may be determined as half of TCP proposed for preamble format A in the NR PRACH table (i.e., Table 3) or (TCP of preamble format B−72) samples (or (TGP of preamble format B+72) samples).

D. L-GP length for CCA gap

i. The L-GP length may be determined as a predefined/preconfigured specific absolute time (e.g., Ncg=768*2\hat{ }u samples (=25 us)), or one symbol (or a multiple thereof) or 0.5 symbols (or a multiple thereof), where u denotes the SCS of Table 1.

E. Note 1

i. To transmit a PRACH format including S symbols+Ncg samples, consecutive ROs may be mapped/allocated within one RACH slot in the time domain.

4) Method 4

A. Total PRACH format duration

i. The Total PRACH format duration may be determined as the sum of the following components.

ii. For example, the total PRACH format duration may be determined as S symbols+Ncg samples.

B. Preamble part length

i. The preamble part length may be determined as one of the preamble part lengths (TSEQ of Table 3) proposed for preamble formats A, B, or C in the NR PRACH table (i.e., Table 3).

C. CP length=GP length

i. The CP/GP length may be determined as one of the CP lengths (TCP of Table 3) proposed for preamble formats A, B, or C in the NR PRACH table (i.e., Table 3).

D. L-GP length for CCA gap

i. The L-GP length may be determined as a predefined/preconfigured specific absolute time (e.g., Ncg=768Au samples (=25 usec)), or one symbol (or a multiple thereof) or 0.5 symbols (or a multiple thereof), where u denotes the SCS of Table 1.

E. Note 1

i. To transmit a PRACH format including S symbols+Ncg samples, consecutive ROs may be mapped/allocated within one RACH slot in the time domain.

5) Method 5

A. PRACH format duration

i. The PRACH format duration may be determined as one of the PRACH format durations (TCP+TSEQ+TGP of Table 3) proposed for preamble formats A, B, or C in the NR PRACH table (i.e., Table 3).

B. L-GP for CCA gap

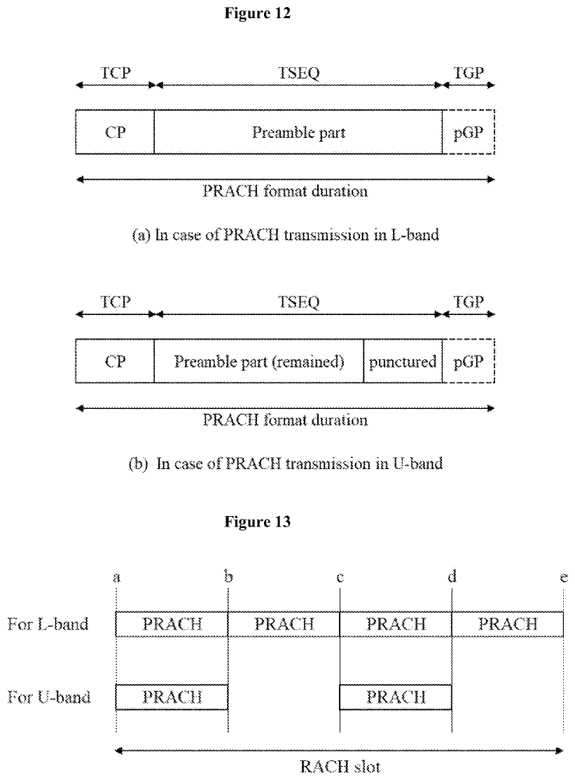

i. The L-GP corresponding to Ncg samples may be configured by puncturing first or last Ncg samples after configuring the structure of {CP+preamble part (+GP)} corresponding to preamble formats A, B, or C in the NR PRACH table (i.e., Table 3). For example, the first or last Ncg samples may be omitted from {TCP+TSEQ+TGP}. FIG. 12 shows a PRACH format structure according to this method. Referring to FIG. 12, when the RACH is performed (transmitted) in an L-band, the UE may transmit the PRACH of Table 3. When the RACH is performed (transmitted) in a U-band, the UE may perform puncturing of an end portion of the preamble part as long as the L-GP in the PRACH format structure of Table 3.

ii. Ncg may be defined as a predefined/preconfigured specific absolute time (e.g., Ncg=768Au samples (=25 us)), or one symbol (or a multiple thereof) or 0.5 symbols (or a multiple thereof), where u denotes the SCS of Table 1.

C. Preamble part length

i. The preamble part length may be determined based on a portion which is not set as the L-GP in the preamble part (TSEQ of Table 3) proposed for preamble formats A, B, or C in the NR PRACH table (i.e., Table 3).

D. CP length=GP length

i. The CP/GP length may be determined based on a portion of which is not set as the L-GP in the CP and GP (TCP and TGP of Table 3) proposed for preamble formats A, B, or C in the NR PRACH table (i.e., Table 3).

The L-GP may be defined/configured as one fixed absolute time (e.g., X usec) or a fixed number of samples (e.g., Y samples) for a plurality of different OFDM numerologies or SCSs (e.g., 15, 30, or 60 kHz). If the L-GP is defined/configured as the number of (OFDM) symbols, the L-GP may increase in proportion to the SCS size. For example, when SCS=15 kHz, the L-GP may be determined as Z symbols (where Z is a real number, for example, Z=0.5 or 1). When SCS=30 or 60 kHz, the L-GP may be determined as 2Z or 4Z symbols.

As another method, when any PRACH format is given in addition to the PRACH format proposed in the present disclosure and the conventional PRACH format defined in NR, the following PRACH resource configuration may be considered to secure a CCA gap between adjacent PRACH resources in the time domain.

(1) Option 1

For a plurality of PRACH (format) resources allocated to each RACH slot, the starting time (e.g., starting symbol) may be configured for each PRACH (format) resource. Option 1 may be applied by substituting the starting time of the PRACH (format) resource with the ending time (e.g., ending symbol).

(2) Option 2

The starting time of the first PRACH (format) resource among a plurality of PRACH (format) resources allocated to each RACH slot and the interval between starting times of the PRACH (format) resources (e.g., starting symbol interval) may be configured. Option 2 may be applied by substituting the starting time of the PRACH (format) resource with the ending time (e.g., ending symbol).

(3) Option 3

The starting/ending time of the first PRACH (format) resource among a plurality of PRACH (format) resources allocated to each RACH slot and the time interval (e.g., resource gap) between two adjacent PRACH (format) resources in the time domain may be configured. Here, the time interval between the two PRACH (format) resources may mean the interval between the ending time of a preceding PRACH resource (in the time domain) and the starting time of a following PRACH resource among the two PRACH (format) resources.

(4) Note

When a PRACH resource gap is configured randomly as well as according to Option 1/2/3, the duration of the PRACH resource gap and the granularity for configuring the corresponding duration may vary depending on signaling for configuring PRACH resources and/or the relationship between a PRACH resource allocation/mapping time and a BS-initiated channel occupancy time (COT), which is occupied by the BS after performing/succeeding in the LBT. The PRACH resource gap may mean the time interval between two adjacent PRACH (format) resources in the time domain allocated within the same RACH slot.

For example, the PRACH resources may be configured by a higher layer signal (e.g., system information block (SIB)) and/or the time at which the PRACH resources are allocated/mapped may not be included within the BS-initiated COT. In this case, the duration/granularity of the PRACH resource gap may be set to one OFDM symbol (or a multiple thereof) or (one or more) multiple OFDM symbols.

In another example, the PRACH resources may be signaled by L1 signaling (e.g., downlink control information (DCI)) and/or the time at which the PRACH resources are allocated/mapped may be included within the BS-initiated COT. In this case, the duration/granularity of the PRACH resource gap may be X us (for example, X<=16, 16<=X<=25, or X=25) or 0.5 OFDM symbols (or a multiple thereof).

FIG. 13 shows PRACH resource allocation according to Option 1/2/3. Referring to FIG. 13, when the RACH is performed (transmitted) in an L-band, ROs for PRACH transmission may be configured to be contiguous in the time domain as shown in FIG. 8. On the other hand, when the RACH is performed (transmitted) in a U-band, ROs may be configured to be non-contiguous within a slot in the time domain according to Option 1/2/3. For example, a gap of at least one OFDM symbol may be configured between two neighboring ROs within a slot (e.g., b to c).

According to Option 1/2/3, the same NR PARCH format may be used regardless of whether a PRACH transmission cell is the L-band or U-band. For example, the PRACH transmission starting time may be aligned with respect to the starting time of a data OFDM symbol in the slot, and a PRACH format may be configured as follows based on the conventional NR PRACH format (Table 3).

TABLE 4

| Format | TCP | TSEQ | TGP |
|---|---|---|---|
| A1 | 288*k*2^{-u} | 2*2048*k*2^{-u} | 0*k*2^{-u} |
| A2 | 576*k*2^{-u} | 4*2048*k*2^{-u} | 0*k*2^{-u} |
| A3 | 864*k*2^{-u} | 6*2048*k*2^{-u} | 0*k*2^{-u} |
| B1 | 216*k*2^{-u} | 2*2048*k*2^{-u} | 72*k*2^{-u} |
| B2 | 360*k*2^{-u} | 4*2048*k*2^{-u} | 216*k*2^{-u} |
| B3 | 504*k*2^{-u} | 6*2048*k*2^{-u} | 360*k*2^{-u} |
| C0 | 1240*k*2^{-u} | 2048*k*2^{-u} | 1096*k*2^{-u} |
| C2 | 2048*k*2^{-u} | 4*2048*k*2^{-u} | 2912*k*2^{-u} |

In Table 4, u is an integer greater than or equal to 0, which is related to the SCS, k is a sampling time when u=0. TCP denotes the time duration of a CP, TSEQ denotes the time duration of a preamble part, and TGP denotes the time duration of a GP. In the PRACH format structure, the GP is not explicitly defined but may be estimated from the total duration of the PRACH format (i.e., a multiple of the duration of the data OFDM symbol).

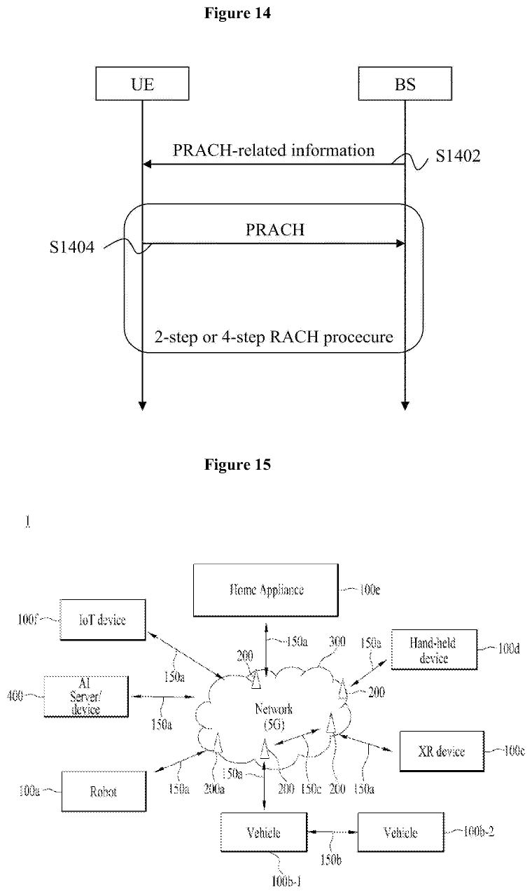

FIG. 14 illustrates a RACH procedure according to an embodiment of the present disclosure. Referring to FIG. 14, a UE may receive PRACH-related information from a BS (S1402). The PRACH-related information includes information about a PRACH resource. For example, the PRACH-related information may include information about the configuration of a RACH slot (e.g., periodicity, offset, etc.), information about the configuration of an RO in the RACH slot (e.g., RO starting symbol), information about the configuration of a PRACH sequence, and so on. The PRACH-related information may be received in system information. Thereafter, the UE may transmit a PRACH on any one RO among a plurality of ROs in the PRACH slot of a cell (S1404). The PRACH may be performed (transmitted) as a part of a 2-/4-step RACH procedure.

In this case, the structure of a PRACH format and the RO configuration may vary depending on whether PRACH transmission cell is an L-band or a U-band. When the PRACH transmission cell operates in the L-band, the PRACH may be transmitted according to the methods described above with reference to FIGS. 7 and 8. On the other hand, when the PRACH transmission cell operates in the U-band, the PRACH may be transmitted according to Methods 1 to 5 and Option 1/2/3 described in this document.

Assuming application of Option 2, if the PRACH transmission cell operations in the U-band, the plurality of ROs in the RACH slot may be configured to be non-contiguous in the time domain (see FIG. 13). To this end, the plurality of ROs may be configured to be non-contiguous based on the starting time of a PRACH (format) resource (or RO starting time) and the interval between starting times of individual PRACH format resources (e.g., starting symbol interval) (or RO interval). The starting time of the PRACH (format) resource and the interval between the starting times of the individual PRACH format resources may be signaled as part of the PRACH-related information. When the PRACH transmission cell operations in the L-band, the plurality of ROs may be configured to be contiguous in the time domain as shown in FIG. 8.

FIG. 15 illustrates a communication system 1 applied to the present disclosure.

Referring to FIG. 15, a communication system 1 applied to the present disclosure includes wireless devices, Base Stations (BSs), and a network. Herein, the wireless devices represent devices performing communication using Radio Access Technology (RAT) (e.g., 5G New RAT (NR)) or Long-Term Evolution (LTE)) and may be referred to as communication/radio/5G devices. The wireless devices may include, without being limited to, a robot 100a, vehicles 100b-1 and 100b-2, an eXtended Reality (XR) device 100c, a hand-held device 100d, a home appliance 100e, an Internet of Things (IoT) device 100f, and an Artificial Intelligence (AI) device/server 400. For example, the vehicles may include a vehicle having a wireless communication function, an autonomous driving vehicle, and a vehicle capable of performing communication between vehicles. Herein, the vehicles may include an Unmanned Aerial Vehicle (UAV) (e.g., a drone). The XR device may include an Augmented Reality (AR)/Virtual Reality (VR)/Mixed Reality (MR) device and may be implemented in the form of a Head-Mounted Device (HMD), a Head-Up Display (HUD) mounted in a vehicle, a television, a smartphone, a computer, a wearable device, a home appliance device, a digital signage, a vehicle, a robot, etc. The hand-held device may include a smartphone, a smartpad, a wearable device (e.g., a smartwatch or a smartglasses), and a computer (e.g., a notebook). The home appliance may include a TV, a refrigerator, and a washing machine. The IoT device may include a sensor and a smartmeter. For example, the BSs and the network may be implemented as wireless devices and a specific wireless device 200a may operate as a BS/network node with respect to other wireless devices.

The wireless devices 100a to 100f may be connected to the network 300 via the BSs 200. An AI technology may be applied to the wireless devices 100a to 100f and the wireless devices 100a to 100f may be connected to the AI server 400 via the network 300. The network 300 may be configured using a 3G network, a 4G (e.g., LTE) network, or a 5G (e.g., NR) network. Although the wireless devices 100a to 100f may communicate with each other through the BSs 200/network 300, the wireless devices 100a to 100f may perform direct communication (e.g., sidelink communication) with each other without passing through the BSs/network. For example, the vehicles 100b-1 and 100b-2 may perform direct communication (e.g. Vehicle-to-Vehicle (V2V)/Vehicle-to-everything (V2X) communication). The IoT device (e.g., a sensor) may perform direct communication with other IoT devices (e.g., sensors) or other wireless devices 100a to 100f.

Wireless communication/connections 150a, 150b, or 150c may be established between the wireless devices 100a to 100f/BS 200, or BS 200/BS 200. Herein, the wireless communication/connections may be established through various RATs (e.g., 5G NR) such as uplink/downlink communication 150a, sidelink communication 150b (or, D2D communication), or inter BS communication (e.g. relay, Integrated Access Backhaul (IAB)). The wireless devices and the BSs/the wireless devices may transmit/receive radio signals to/from each other through the wireless communication/connections 150a and 150b. For example, the wireless communication/connections 150a and 150b may transmit/receive signals through various physical channels. To this end, at least a part of various configuration information configuring processes, various signal processing processes (e.g., channel encoding/decoding, modulation/demodulation, and resource mapping/demapping), and resource allocating processes, for transmitting/receiving radio signals, may be performed based on the various proposals of the present disclosure.

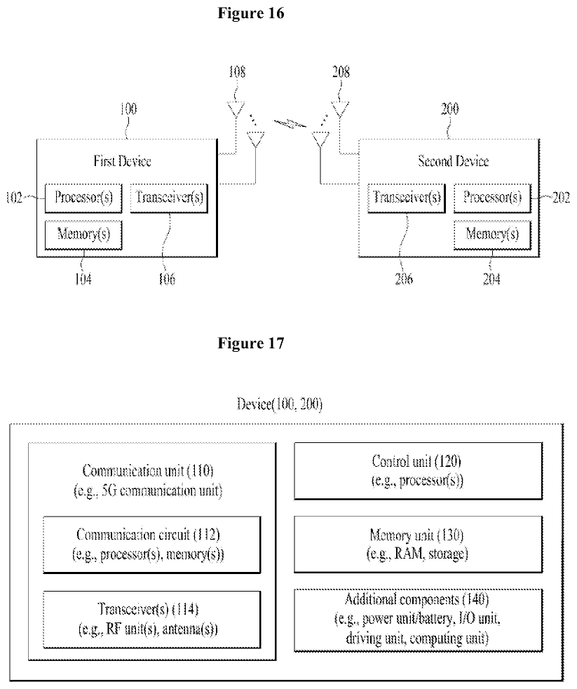

FIG. 16 illustrates wireless devices applicable to the present disclosure.

Referring to FIG. 16, a first wireless device 100 and a second wireless device 200 may transmit radio signals through a variety of RATs (e.g., LTE and NR). Herein, {the first wireless device 100 and the second wireless device 200} may correspond to {the wireless device 100x and the BS 200} and/or {the wireless device 100x and the wireless device 100x} of FIG. 15.

The first wireless device 100 may include one or more processors 102 and one or more memories 104 and additionally further include one or more transceivers 106 and/or one or more antennas 108. The processor(s) 102 may control the memory(s) 104 and/or the transceiver(s) 106 and may be configured to implement the descriptions, functions, procedures, proposals, methods, and/or operational flowcharts disclosed in this document. For example, the processor(s) 102 may process information within the memory(s) 104 to generate first information/signals and then transmit radio signals including the first information/signals through the transceiver(s) 106. The processor(s) 102 may receive radio signals including second information/signals through the transceiver 106 and then store information obtained by processing the second information/signals in the memory(s) 104. The memory(s) 104 may be connected to the processor(s) 102 and may store a variety of information related to operations of the processor(s) 102. For example, the memory(s) 104 may store software code including commands for performing a part or the entirety of processes controlled by the processor(s) 102 or for performing the descriptions, functions, procedures, proposals, methods, and/or operational flowcharts disclosed in this document. Herein, the processor(s) 102 and the memory(s) 104 may be a part of a communication modem/circuit/chip designed to implement RAT (e.g., LTE or NR). The transceiver(s) 106 may be connected to the processor(s) 102 and transmit and/or receive radio signals through one or more antennas 108. Each of the transceiver(s) 106 may include a transmitter and/or a receiver. The transceiver(s) 106 may be interchangeably used with Radio Frequency (RF) unit(s). In the present disclosure, the wireless device may represent a communication modem/circuit/chip.

The second wireless device 200 may include one or more processors 202 and one or more memories 204 and additionally further include one or more transceivers 206 and/or one or more antennas 208. The processor(s) 202 may control the memory(s) 204 and/or the transceiver(s) 206 and may be configured to implement the descriptions, functions, procedures, proposals, methods, and/or operational flowcharts disclosed in this document. For example, the processor(s) 202 may process information within the memory(s) 204 to generate third information/signals and then transmit radio signals including the third information/signals through the transceiver(s) 206. The processor(s) 202 may receive radio signals including fourth information/signals through the transceiver(s) 106 and then store information obtained by processing the fourth information/signals in the memory(s) 204. The memory(s) 204 may be connected to the processor(s) 202 and may store a variety of information related to operations of the processor(s) 202. For example, the memory(s) 204 may store software code including commands for performing a part or the entirety of processes controlled by the processor(s) 202 or for performing the descriptions, functions, procedures, proposals, methods, and/or operational flowcharts disclosed in this document. Herein, the processor(s) 202 and the memory(s) 204 may be a part of a communication modem/circuit/chip designed to implement RAT (e.g., LTE or NR). The transceiver(s) 206 may be connected to the processor(s) 202 and transmit and/or receive radio signals through one or more antennas 208. Each of the transceiver(s) 206 may include a transmitter and/or a receiver. The transceiver(s) 206 may be interchangeably used with RF unit(s). In the present disclosure, the wireless device may represent a communication modem/circuit/chip.

Hereinafter, hardware elements of the wireless devices 100 and 200 will be described more specifically. One or more protocol layers may be implemented by, without being limited to, one or more processors 102 and 202. For example, the one or more processors 102 and 202 may implement one or more layers (e.g., functional layers such as PHY, MAC, RLC, PDCP, RRC, and SDAP). The one or more processors 102 and 202 may generate one or more Protocol Data Units (PDUs) and/or one or more Service Data Unit (SDUs) according to the descriptions, functions, procedures, proposals, methods, and/or operational flowcharts disclosed in this document. The one or more processors 102 and 202 may generate messages, control information, data, or information according to the descriptions, functions, procedures, proposals, methods, and/or operational flowcharts disclosed in this document. The one or more processors 102 and 202 may generate signals (e.g., baseband signals) including PDUs, SDUs, messages, control information, data, or information according to the descriptions, functions, procedures, proposals, methods, and/or operational flowcharts disclosed in this document and provide the generated signals to the one or more transceivers 106 and 206. The one or more processors 102 and 202 may receive the signals (e.g., baseband signals) from the one or more transceivers 106 and 206 and acquire the PDUs, SDUs, messages, control information, data, or information according to the descriptions, functions, procedures, proposals, methods, and/or operational flowcharts disclosed in this document.

The one or more processors 102 and 202 may be referred to as controllers, microcontrollers, microprocessors, or microcomputers. The one or more processors 102 and 202 may be implemented by hardware, firmware, software, or a combination thereof. As an example, one or more Application Specific Integrated Circuits (ASICs), one or more Digital Signal Processors (DSPs), one or more Digital Signal Processing Devices (DSPDs), one or more Programmable Logic Devices (PLDs), or one or more Field Programmable Gate Arrays (FPGAs) may be included in the one or more processors 102 and 202. The descriptions, functions, procedures, proposals, methods, and/or operational flowcharts disclosed in this document may be implemented using firmware or software and the firmware or software may be configured to include the modules, procedures, or functions. Firmware or software configured to perform the descriptions, functions, procedures, proposals, methods, and/or operational flowcharts disclosed in this document may be included in the one or more processors 102 and 202 or stored in the one or more memories 104 and 204 so as to be driven by the one or more processors 102 and 202. The descriptions, functions, procedures, proposals, methods, and/or operational flowcharts disclosed in this document may be implemented using firmware or software in the form of code, commands, and/or a set of commands.

The one or more memories 104 and 204 may be connected to the one or more processors 102 and 202 and store various types of data, signals, messages, information, programs, code, instructions, and/or commands. The one or more memories 104 and 204 may be configured by Read-Only Memories (ROMs), Random Access Memories (RAMs), Electrically Erasable Programmable Read-Only Memories (EPROMs), flash memories, hard drives, registers, cash memories, computer-readable storage media, and/or combinations thereof. The one or more memories 104 and 204 may be located at the interior and/or exterior of the one or more processors 102 and 202. The one or more memories 104 and 204 may be connected to the one or more processors 102 and 202 through various technologies such as wired or wireless connection.

The one or more transceivers 106 and 206 may transmit user data, control information, and/or radio signals/channels, mentioned in the methods and/or operational flowcharts of this document, to one or more other devices. The one or more transceivers 106 and 206 may receive user data, control information, and/or radio signals/channels, mentioned in the descriptions, functions, procedures, proposals, methods, and/or operational flowcharts disclosed in this document, from one or more other devices. For example, the one or more transceivers 106 and 206 may be connected to the one or more processors 102 and 202 and transmit and receive radio signals. For example, the one or more processors 102 and 202 may perform control so that the one or more transceivers 106 and 206 may transmit user data, control information, or radio signals to one or more other devices. The one or more processors 102 and 202 may perform control so that the one or more transceivers 106 and 206 may receive user data, control information, or radio signals from one or more other devices. The one or more transceivers 106 and 206 may be connected to the one or more antennas 108 and 208 and the one or more transceivers 106 and 206 may be configured to transmit and receive user data, control information, and/or radio signals/channels, mentioned in the descriptions, functions, procedures, proposals, methods, and/or operational flowcharts disclosed in this document, through the one or more antennas 108 and 208. In this document, the one or more antennas may be a plurality of physical antennas or a plurality of logical antennas (e.g., antenna ports). The one or more transceivers 106 and 206 may convert received radio signals/channels etc. from RF band signals into baseband signals in order to process received user data, control information, radio signals/channels, etc. using the one or more processors 102 and 202. The one or more transceivers 106 and 206 may convert the user data, control information, radio signals/channels, etc. processed using the one or more processors 102 and 202 from the base band signals into the RF band signals. To this end, the one or more transceivers 106 and 206 may include (analog) oscillators and/or filters.

FIG. 17 illustrates another example of a wireless device applied to the present disclosure. The wireless device may be implemented in various forms according to a use-case/service (refer to FIG. 15).

Referring to FIG. 17, wireless devices 100 and 200 may correspond to the wireless devices 100 and 200 of FIG. 16 and may be configured by various elements, components, units/portions, and/or modules. For example, each of the wireless devices 100 and 200 may include a communication unit 110, a control unit 120, a memory unit 130, and additional components 140. The communication unit may include a communication circuit 112 and transceiver(s) 114. For example, the communication circuit 112 may include the one or more processors 102 and 202 and/or the one or more memories 104 and 204 of FIG. 16. For example, the transceiver(s) 114 may include the one or more transceivers 106 and 206 and/or the one or more antennas 108 and 208 of FIG. 16. The control unit 120 is electrically connected to the communication unit 110, the memory 130, and the additional components 140 and controls overall operation of the wireless devices. For example, the control unit 120 may control an electric/mechanical operation of the wireless device based on programs/code/commands/information stored in the memory unit 130. The control unit 120 may transmit the information stored in the memory unit 130 to the exterior (e.g., other communication devices) via the communication unit 110 through a wireless/wired interface or store, in the memory unit 130, information received through the wireless/wired interface from the exterior (e.g., other communication devices) via the communication unit 110.

The additional components 140 may be variously configured according to types of wireless devices. For example, the additional components 140 may include at least one of a power unit/battery, input/output (I/O) unit, a driving unit, and a computing unit. The wireless device may be implemented in the form of, without being limited to, the robot (100a of FIG. 15), the vehicles (100b-1 and 100b-2 of FIG. 15), the XR device (100c of FIG. 15), the hand-held device (100d of FIG. 15), the home appliance (100e of FIG. 15), the IoT device (100f of FIG. 15), a digital broadcast terminal, a hologram device, a public safety device, an MTC device, a medicine device, a fintech device (or a finance device), a security device, a climate/environment device, the AI server/device (400 of FIG. 15), the BSs (200 of FIG. 15), a network node, etc. The wireless device may be used in a mobile or fixed place according to a use-example/service.

In FIG. 17, the entirety of the various elements, components, units/portions, and/or modules in the wireless devices 100 and 200 may be connected to each other through a wired interface or at least a part thereof may be wirelessly connected through the communication unit 110. For example, in each of the wireless devices 100 and 200, the control unit 120 and the communication unit 110 may be connected by wire and the control unit 120 and first units (e.g., 130 and 140) may be wirelessly connected through the communication unit 110. Each element, component, unit/portion, and/or module within the wireless devices 100 and 200 may further include one or more elements. For example, the control unit 120 may be configured by a set of one or more processors. As an example, the control unit 120 may be configured by a set of a communication control processor, an application processor, an Electronic Control Unit (ECU), a graphical processing unit, and a memory control processor. As another example, the memory 130 may be configured by a Random Access Memory (RAM), a Dynamic RAM (DRAM), a Read Only Memory (ROM)), a flash memory, a volatile memory, a non-volatile memory, and/or a combination thereof.

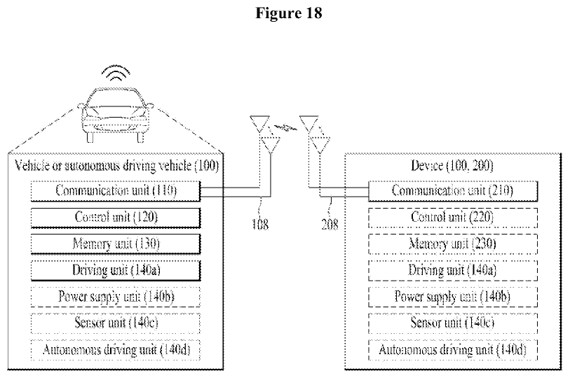

FIG. 18 illustrates a vehicle or an autonomous driving vehicle applied to the present disclosure. The vehicle or autonomous driving vehicle may be implemented by a mobile robot, a car, a train, a manned/unmanned Aerial Vehicle (AV), a ship, etc.

Referring to FIG. 18, a vehicle or autonomous driving vehicle 100 may include an antenna unit 108, a communication unit 110, a control unit 120, a driving unit 140a, a power supply unit 140b, a sensor unit 140c, and an autonomous driving unit 140d. The antenna unit 108 may be configured as a part of the communication unit 110. The blocks 110/130/140a to 140d correspond to the blocks 110/130/140 of FIG. 17, respectively.

The communication unit 110 may transmit and receive signals (e.g., data and control signals) to and from external devices such as other vehicles, BSs (e.g., gNBs and road side units), and servers. The control unit 120 may perform various operations by controlling elements of the vehicle or the autonomous driving vehicle 100. The control unit 120 may include an Electronic Control Unit (ECU). The driving unit 140a may cause the vehicle or the autonomous driving vehicle 100 to drive on a road. The driving unit 140a may include an engine, a motor, a powertrain, a wheel, a brake, a steering device, etc. The power supply unit 140b may supply power to the vehicle or the autonomous driving vehicle 100 and include a wired/wireless charging circuit, a battery, etc. The sensor unit 140c may acquire a vehicle state, ambient environment information, user information, etc. The sensor unit 140c may include an Inertial Measurement Unit (IMU) sensor, a collision sensor, a wheel sensor, a speed sensor, a slope sensor, a weight sensor, a heading sensor, a position module, a vehicle forward/backward sensor, a battery sensor, a fuel sensor, a tire sensor, a steering sensor, a temperature sensor, a humidity sensor, an ultrasonic sensor, an illumination sensor, a pedal position sensor, etc. The autonomous driving unit 140d may implement technology for maintaining a lane on which a vehicle is driving, technology for automatically adjusting speed, such as adaptive cruise control, technology for autonomously driving along a determined path, technology for driving by automatically setting a path if a destination is set, and the like.

For example, the communication unit 110 may receive map data, traffic information data, etc. from an external server. The autonomous driving unit 140d may generate an autonomous driving path and a driving plan from the obtained data. The control unit 120 may control the driving unit 140a such that the vehicle or the autonomous driving vehicle 100 may move along the autonomous driving path according to the driving plan (e.g., speed/direction control). In the middle of autonomous driving, the communication unit 110 may aperiodically/periodically acquire recent traffic information data from the external server and acquire surrounding traffic information data from neighboring vehicles. In the middle of autonomous driving, the sensor unit 140c may obtain a vehicle state and/or surrounding environment information. The autonomous driving unit 140d may update the autonomous driving path and the driving plan based on the newly obtained data/information. The communication unit 110 may transfer information about a vehicle position, the autonomous driving path, and/or the driving plan to the external server. The external server may predict traffic information data using AI technology, etc., based on the information collected from vehicles or autonomous driving vehicles and provide the predicted traffic information data to the vehicles or the autonomous driving vehicles.

The above-described embodiments correspond to combinations of elements and features of the present disclosure in prescribed forms. And, the respective elements or features may be considered as selective unless they are explicitly mentioned. Each of the elements or features can be implemented in a form failing to be combined with other elements or features. Moreover, it is able to implement an embodiment of the present disclosure by combining elements and/or features together in part. A sequence of operations explained for each embodiment of the present disclosure can be modified. Some configurations or features of one embodiment can be included in another embodiment or can be substituted for corresponding configurations or features of another embodiment. And, it is apparently understandable that an embodiment is configured by combining claims failing to have relation of explicit citation in the appended claims together or can be included as new claims by amendment after filing an application.

Those skilled in the art will appreciate that the present disclosure may be carried out in other specific ways than those set forth herein without departing from the spirit and essential characteristics of the present disclosure. The above embodiments are therefore to be construed in all aspects as illustrative and not restrictive. The scope of the disclosure should be determined by the appended claims and their legal equivalents, not by the above description, and all changes coming within the meaning and equivalency range of the appended claims are intended to be embraced therein.

### INDUSTRIAL APPLICABILITY

The present disclosure is applicable to UEs, eNBs or other apparatuses of a wireless mobile communication system.

1. A method of performing a random access channel (RACH) by a communication device in a wireless communication system, the method comprising:
receiving information about a physical random access channel (PRACH) resource; and
transmitting a PRACH on any one RACH occasion (RO) among a plurality of ROs within a PRACH slot of a cell based on the information,
wherein based on that the cell operates in an unlicensed band (U-band), the plurality of ROs are configured to be non-contiguous in a time domain.

2. The method of claim 1, wherein based on that the cell operates in a licensed band (L-band), the plurality of ROs are configured to be contiguous in the time domain.

3. The method of claim 2, wherein a starting time of the PRACH transmission is aligned with respect to a starting time of an orthogonal frequency division multiplexing (OFDM) symbol for data within the slot, and
wherein a cyclic prefix (CP), a preamble part, and a guard period are configured depending on formats in the following table:

| Format | TCP | TSEQ | TGP |
|---|---|---|---|
| A1 | 288*k*2^{-u} | 2*2048*k*2^{-u} | 0*k*2^{-u} |
| A2 | 576*k*2^{-u} | 4*2048*k*2^{-u} | 0*k*2^{-u} |
| A3 | 864*k*2^{-u} | 6*2048*k*2^{-u} | 0*k*2^{-u} |
| B1 | 216*k*2^{-u} | 2*2048*k*2^{-u} | 72*k*2^{-u} |
| B2 | 360*k*2^{-u} | 4*2048*k*2^{-u} | 216*k*2^{-u} |
| B3 | 504*k*2^{-u} | 6*2048*k*2^{-u} | 360*k*2^{-u} |
| C0 | 1240*k*2^{-u} | 2048*k*2^{-u} | 1096*k*2^{-u} |
| C2 | 2048*k*2^{-u} | 4*2048*k*2^{-u} | 2912*k*2^{-u} |

where u is an integer greater than or equal to 0 and related to a subcarrier spacing (SCS), k is a sampling time when u=0, TCP denotes a time duration of the CP, TSEQ denotes a time duration of the preamble part, and TGP denotes a time duration of the GP.

4. The method of claim 1, wherein the information includes information about an RO starting time and an RO interval, and wherein based on that the cell operates in the U-band, the plurality of ROs are configured to be non-contiguous in the time domain based on the RO starting time and the RO interval.

5. The method of claim 4, wherein based on the RO interval, two adjacent ROs are configured to be apart from each other by at least one orthogonal frequency division multiplexing (OFDM) symbol within the slot.

6. The method of claim 1, wherein the wireless communication system includes a 3rd Generation Partnership Project (3GPP) based wireless communication system.

7. A communication device for use in a wireless communication system, the communication device comprising:
a memory; and
a processor, the processor is configured to:
receive information about a physical random access channel (PRACH) resource; and
transmit a PRACH on any one RACH occasion (RO) among a plurality of ROs within a PRACH slot of a cell based on the information,
wherein based on that the cell operates in an unlicensed band (U-band), the plurality of ROs are configured to be non-contiguous in a time domain.

8. The communication device of claim 7, wherein based on that the cell operates in a licensed band (L-band), the plurality of ROs are configured to be contiguous in the time domain.

9. The communication device of claim 8, wherein a starting time of the PRACH transmission is aligned with respect to a starting time of an orthogonal frequency division multiplexing (OFDM) symbol for data within the slot, and
wherein a cyclic prefix (CP), a preamble part, and a guard period are configured depending on formats in the following table:

| Format | TCP | TSEQ | TGP |
|---|---|---|---|
| A1 | 288*k*2^{-u} | 2*2048*k*2^{-u} | 0*k*2^{-u} |
| A2 | 576*k*2^{-u} | 4*2048*k*2^{-u} | 0*k*2^{-u} |
| A3 | 864*k*2^{-u} | 6*2048*k*2^{-u} | 0*k*2^{-u} |
| B1 | 216*k*2^{-u} | 2*2048*k*2^{-u} | 72*k*2^{-u} |
| B2 | 360*k*2^{-u} | 4*2048*k*2^{-u} | 216*k*2^{-u} |
| B3 | 504*k*2^{-u} | 6*2048*k*2^{-u} | 360*k*2^{-u} |
| C0 | 1240*k*2^{-u} | 2048*k*2^{-u} | 1096*k*2^{-u} |
| C2 | 2048*k*2^{-u} | 4*2048*k*2^{-u} | 2912*k*2^{-u} |

where u is an integer greater than or equal to 0 and related to a subcarrier spacing (SCS), k is a sampling time when u=0, TCP denotes a time duration of the CP, TSEQ denotes a time duration of the preamble part, and TGP denotes a time duration of the GP.

10. The communication device of claim 7, wherein the information includes information about an RO starting time and an RO interval, and wherein based on that the cell operates in the U-band, the plurality of ROs are configured to be non-contiguous in the time domain based on the RO starting time and the RO interval.

11. The communication device of claim 10, wherein based on the RO interval, two adjacent ROs are configured to be apart from each other by at least one orthogonal frequency division multiplexing (OFDM) symbol within the slot.

12. The communication device of claim 7, wherein the wireless communication system includes a 3rd Generation Partnership Project (3GPP) based wireless communication system.

13. The communication device of claim 7, wherein the communication device includes an autonomous driving vehicle configured to communicate at least with a terminal, a network, and another autonomous driving vehicle other than the communication device.
